(19) United States
(12) Patent Application Publication
(10) Pub. No.: US 2015/0183479 A1
(43) Pub. Date: Jul. 2, 2015

(54) Motorcycle Air Jet Heat Shield

(71) Applicants: Douglas Brian Wagoner, Idaho Falls, ID (US); William Thor Zollinger, Idaho Falls, ID (US)

(72) Inventors: Douglas Brian Wagoner, Idaho Falls, ID (US); William Thor Zollinger, Idaho Falls, ID (US)

(21) Appl. No.: 14/142,202

(22) Filed: Dec. 27, 2013

(51) Int. Cl. B62J 17/00; F01N 13/14; B60K 11/06

(52) U.S. Cl. CPC B62J 17/00; B60K 11/06; F01N 13/14

(57) ABSTRACT

The objective of the present invention is to use the principle of an air jet to draw hot air away from the rear of a motorcycle engine for improved cooling, while shielding the leg of the rider from engine and exhaust heat. By reducing heat buildup, the present invention prevents heat discoloration of the intake manifold and carburetor and improves fuel atomization within the carburetor.

### RELATED APPLICATIONS

The present application is related to U.S. Pat. No. 4,955,193 A, issued Jul. 17, 1989, for ADJUSTABLE SHIELD FOR MOTORCYCLE EXHAUST PIPE, by Herbert W. Hoeptner, III, included by reference herein.

The present application is related to U.S. Pat. No. 5,966,933 A, issued Sep. 17, 1997, for COVERING UNIT FOR MOTORCYCLE EXHAUST SYSTEM, by Satoshi Ishihara, Shinichi Ookawa, included by reference herein.

The present application is related to U.S. Pat. No. 6,179,313 B1, issued Aug. 23, 1999, for MOTORCYCLE EXHAUST PIPE HEAT SHIELD AND METHOD OF MAKING SAME, by Daniel C. Christensen, included by reference herein.

The present application is related to U.S. Pat. No. 5,966,933 A, issued Sep. 17, 1997, for COVERING UNIT FOR MOTORCYCLE EXHAUST SYSTEM, by Satoshi Ishihara, Shinichi Ookawa, included by reference herein.

The present application is related to U.S. Pat. No. 8,028,795 B2, issued Nov. 12, 2009, for EXHAUST COMPONENT COVER, by Toru Hisanaga, Akihiro Kawamata, Shingo Oshimizu, Tomoyuki Uchida, included by reference herein.

The present application is related to United States patent number US 20080006329 A1, issued Jul. 6, 2007, for AIR GUIDE PLATE, by Takero Shibukawa, Yutaka Yamakura, included by reference herein.

The present application is related to U.S. Pat. No. 7,556,292 B2, issued Mar. 6, 2006, for MOTORCYCLE HEAT SHIELD, by Patrick E. King, included by reference herein.

The present application is related to U.S. Pat. No. 6,854,542 B2, issued Aug. 20, 2002, for MOTORCYCLE V-TWIN ENGINE HEAT DEFLECTOR, by Robert J. Schoonover, included by reference herein.

The present application is related to United States patent number US 20040021352 A1, issued Aug. 2, 2002, for MOTORCYCLE HEAT DEFLECTOR, by Joseph Montone, included by reference herein.

The present application is related to U.S. Pat. No. 7,367,577 B1, issued Dec. 13, 2004, for MOTORCYCLE THIGH PROTECTOR, by Mike Garrett, included by reference herein.

Heat shields have become a common aftermarket part to add to custom motorcycles. The heat shield in question prevents the rider from burning his upper thigh on the exhaust piping of the motorcycle. The closest examples include U.S. Pat. No. 6,854,542 B2 which details an engine heat deflector up by the seat. Like all of the other commercial heat deflectors near the saddle made from rigid materials, the device traps air up behind the rear cylinder head preventing it from burning the leg of the rider on longer drives.

Other examples of prior art include Motorcycle Heat Deflector US20040021352 A1, Motorcycle Thigh Protector U.S. Pat. No. 7,367,577, and Motorcycle Heat Shield U.S. Pat. No. 7,556,292 B2. These applications detail flexible multi-layer heat deflectors which hang down out from under the seat in the same general location next to the rear cylinder head and exhaust piping. These deflectors act more like a blanket, trapping heat behind the deflector and keeping it away from the rider. These devices have similar problems to the rigid deflectors, trapping engine heat up around the rear of the engine.

There are also several inventions which detail methods of shielding heat from just the exhaust piping from the rider, ignoring heat from the rear cylinder head. These devices include U.S. Pat. No. 4,955,193 A, which encloses the exhaust pipe in a bellows style flexible tube, and U.S. Pat. No. 5,966,933 A, which encloses a portion of the exhaust piping in a protective heat shield ahead of the muffler. U.S. Pat. No. 6,179,313 B1 is similar in nature, adding a rigid shield adjacent to the foot of the rider to shield the foot from direct exhaust heat. None of these devices shield the rider from heat generated by the rear cylinder head and intake piping, which is one of the main goals of the current invention.

There is also a device described in U.S. Pat. No. 8,028,795 B2 which surrounds a portion of the exhaust system, using a perforated cover. It's intent is to allow air to flow in under the cover to help cool the cover assembly. It does not use the air jet principle to draw air out from under the heat shield as in the current invention, nor is it in the same location on the motorcycle.

### FIELD OF THE INVENTION

The present invention relates to an improvement to a motorcycle exhaust heat shield, adding a set of strategically placed holes into the heat shield to form an air jet pump. Air passing over the air jet holes creates a low pressure area, drawing hot air out of the vicinity of the motorcycle's rear cylinder head, air intake piping and carburetor.

### BACKGROUND OF THE INVENTION

FIG. 1 depicts a conventional motorcycle having an internal combustion engine with right side exhaust pipes 16. The rear cylinder head 14 and exhaust piping 16 generate a significant amount of heat, affecting the riders legs on both sides of the motorcycle. Commonly, a heat shield 12 is attached to the motorcycle just below the saddle 11 to block heat from the rider's thigh at the location where the heat is the most intense, up near the top of the rear cylinder head 14. The heat shield 12 forms a forward facing cup shape, holding air inside it as the motorcycle moves in a forward direction. Current designs trap hot air up around the rear cylinder head 14 which raises the temperature of adjacent components, including the air intake cover 15 and carburetor assembly (hidden behind item 15).

Excessive heat buildup in this location can be seen as brown and blue heat discoloration of the intake filter cover 15 and carburetor. This discoloration is seen as a detraction to the appearance of the motorcycle which fastidious riders wipe or polish off between rides. Additionally the excessive heat causes poor atomization of the fuel within the carburetor, resulting in lower engine efficiency.

### SUMMARY OF THE INVENTION

The objective of the present invention is to use the principle of an air jet to draw hot air away from the rear of the engine for improved cooling, while shielding the leg of the rider from engine and exhaust heat. By reducing heat buildup, the present invention prevents heat discoloration of the intake manifold and carburetor and improves fuel atomization within the carburetor.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a right elevation view of a side portion of a conventional motorcycle with a variation of the heat shield of this invention mounted thereon.

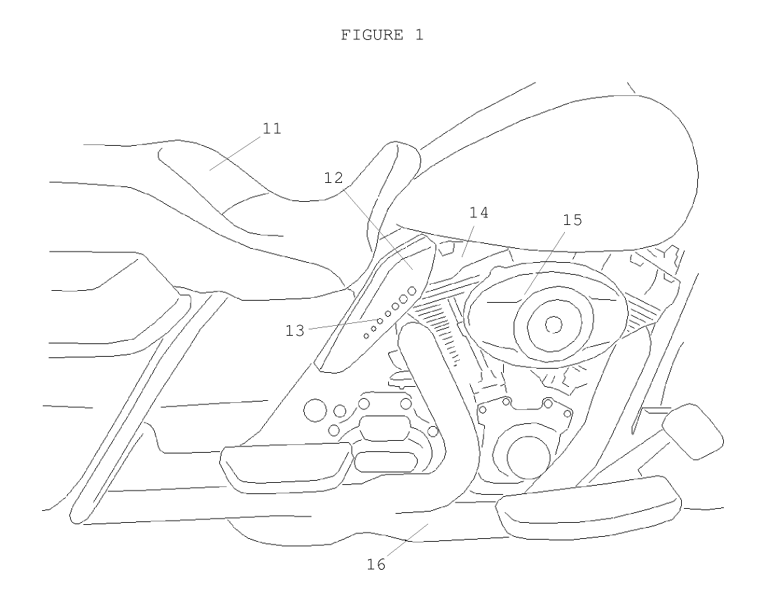

For purposes of clarity and brevity, like elements and components will bear the same designations and numbering throughout the FIGURES.

### DESCRIPTION OF THE PREFERRED EMBODIMENT

The solution to the heat buildup problem is to assist air in moving out from behind the heat shield 12. A set of air jet holes 13 are placed in the heat shield 12 diagonally in an attractive manner along the forward edge of the heat shield 12. Air passing over the outside surface of the heat shield 12 passes over the air jet holes 13 forming a low pressure area in the location of each hole. The pressure of the air trapped inside the heat shield 12 is much higher than that passing over the outer surface of the heat shield 12. This pressure differential causes air to flow from the higher pressure region inside the heat shield 12 through the air jet holes 13 to the outside of the heat shield 12, forming an air jet. The holes are positioned to direct the jets of air below the saddle 11 and away from the rider's thigh. It should also be noted that the air jet holes 13 are positioned near the upper end of the rear exhaust pipe 16 where heat generation is the most extreme.

Air flowing through the air jet holes 13 then flows rearwards towards the back of the motorcycle away from the rider. The addition of this flow of air reduces heat buildup in the area of the air intake manifold 15 as well as up behind the rear cylinder head 14. The effect of the air jet cooling can be seen in the air intake manifold 15. It retains it's normal chrome coloration during rides. The brown and blue heat discoloration (removed by wiping and polishing between rides) does not return after the air jet holes 13 are in place.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A motorcycle air jet heat shield for an improved motorcycle heat shield wherein the exhaust heat shield has an integral air jet pump to draw hot air away from the intake piping and carburetor, preventing heat discoloration, comprising:
means for protecting the rider's thigh from heat; and
means for creating a low pressure zone to draw hot air out from behind the heat shield.

2. The motorcycle air jet heat shield in accordance with claim 1, wherein said means for protecting the rider's thigh from heat comprises a rigid heat shield.

3. The motorcycle air jet heat shield in accordance with claim 1, wherein said means for creating a low pressure zone to draw hot air out from behind the heat shield comprises a set of holes in the heat shield, positioned near the leading edge of the heat shield air jet holes.

4. A motorcycle air jet heat shield for an improved motorcycle heat shield wherein the exhaust heat shield has an integral air jet pump to draw hot air away from the intake piping and carburetor, preventing heat discoloration, comprising:
a rigid heat shield, for protecting the rider's thigh from heat; and
a set of holes in the heat shield, positioned near the leading edge of the heat shield air jet holes, for creating a low pressure zone to draw hot air out from behind the heat shield.

5. A motorcycle air jet heat shield for an improved motorcycle heat shield wherein the exhaust heat shield has an integral air jet pump to draw hot air away from the intake piping and carburetor, preventing heat discoloration, comprising:
a rigid heat shield, for protecting the rider's thigh from heat; and
a set of holes in the heat shield, positioned near the leading edge of the heat shield air jet holes, for creating a low pressure zone to draw hot air out from behind the heat shield.
